(19) United States
(12) Patent Application Publication
(10) Pub. No.: US 2019/0197584 A1
(43) Pub. Date: Jun. 27, 2019

(54) TRACKING TIME AND CONTEXT OF USE OF A COMMUNICATION DEVICE

(71) Applicant: Fitbit, Inc., San Francisco, CA (US)

(72) Inventors: Eric Migicovsky, Vancouver (CA); Yoon Kean Wong, Redwood City, CA (US); Dan Torres, San Carlos, CA (US)

(21) Appl. No.: 16/288,091

(22) Filed: Feb. 27, 2019

Related U.S. Application Data
(63) Continuation of application No. 14/693,635, filed on Apr. 22, 2015, now abandoned.

(51) Int. Cl. G06Q 30/02; H04W 4/24; H04M 15/00

(52) U.S. Cl. CPC G06Q 30/0267; H04M 15/8083; H04W 4/24

(57) ABSTRACT

A method, apparatus, and system relating to tracking the display time and context of the use of a communication device and using the tracked time and context to grant a credit.

### CROSS REFERENCE TO RELATED APPLICATIONS

This application is a continuation of U.S. application Ser. No. 14/693,635, filed Apr. 22, 2015, entitled “TRACKING TIME AND CONTEXT OF USE OF A COMMUNICATION DEVICE,” which is incorporated herein by reference for all purposes.

### BACKGROUND OF THE INVENTION

### 1. Field of the Invention

The invention relates generally to a method, system, and apparatus for tracking the display time and context of the use of a communication device.

### 2. Description of the Related Art

Mobile communication devices, such as smartphones, have long allowed their users to interact and communicate with users of other communication devices. Over time, such communication devices have evolved to include additional hardware that allows for tracking of the user's contextual usage of the communication device. For instance, many smartphones have hardware that allows for the movement of the user of the device to be tracked. As examples, both the Apple iPhone® and Samsung Galaxy® series of smartphones include accelerometers, gyroscopes, and/or magnetometers, which alone or in combination, may be very useful in determining the position, orientation, and movement of the communication device. Smartphone applications may take advantage of this hardware to track the context of the use of the communication device. For example, the jogging application RunKeeper® allows for a user to track the duration, speed, and jogging path of his or her jog session. If the phone is in the user's hand or tethered to the user's arm as the user runs, the combination of the accelerometer and gyroscope may also detect the swinging motion of the phone as a running motion and automatically launch the RunKeeper® application without user intervention.

Mobile communication devices have further evolved to include accessory devices such as smartwatches or other wearable accessory devices. The accessory devices work with mobile devices, such as smartphones, to provide users with increased utility by, for example, allowing the user to view information on the accessory device instead of having to look at the mobile device, which may be in the user's pocket, briefcase, or purse.

Like smartphones, these accessory devices (e.g., a smartwatch), may also be used to detect the context of the user of the device. For example, when a user is wearing a smartwatch equipped with an accelerometer, the movement of the watch when the user is running may also cause the RunKeeper® application to launch on the linked smartphone or on the smartwatch itself. Similarly, the RunKeeper® application may utilize the accelerometer hardware of the smartwatch to track the user's movement, rather than the accelerometer hardware of the smartphone. This may be advantageous, as the smartphone may not necessarily be in the user's hand when the user jogs.

As communication devices have further evolved, becoming more complex and gaining more contextual tracking capabilities, additional uses for the tracking of contextual information have become available. Therefore, it is desirable to provide techniques that allow for the specific tracking of the time and context of the usage of communication devices and using that contextual information in a way that benefits the user of the device.

### SUMMARY OF THE INVENTION

Implementations of the presently disclosed technology relate to a communication device for tracking the time and contextual usage of a communication device. The presently disclosed technology also relates to granting the user of the communication device a credit based on the calculated amount of time the communication device has been used in a certain context, based on the tracked contextual usage information.

### BRIEF DESCRIPTION OF THE FIGURES

The accompanying drawings, which are incorporated in and constitute a part of this specification, illustrate an implementation of apparatuses and methods consistent with the present invention and, together with the detailed description, serve to explain advantages and principles consistent with the invention.

FIG. 1 is an exemplary network comprising an external communication device, network-connected device, and remote server connected together to incorporate an embodiment of the present invention.

FIG. 2 illustrates one embodiment of the present embodiment, wherein the contextual usage of a watch face is tracked in order to award a user credit.

FIG. 3 is a flow chart illustrating the method of the embodiment illustrated in FIG. 2

FIG. 4 illustrates a flow chart for an alternative embodiment, where a watch face is automatically displayed based on contextual information.

### DETAILED DESCRIPTION OF THE PREFERRED EMBODIMENTS

The following detailed description is merely illustrative in nature and is not intended to limit the embodiments of the subject matter or the application and uses of such embodiments. Any implementation described herein as exemplary is not necessarily to be construed as preferred or advantageous over other implementations.

For simplicity and clarity of illustration, the Figures depict the general methodology and/or manner of construction of the various embodiments. Descriptions and details of well-known features and techniques may be omitted to avoid unnecessarily obscuring other features.

Terms of enumeration such as “first,” “second,” “third,” and the like may be used for distinguishing between similar elements and not necessarily for describing a particular spatial or chronological order. These terms, so used, are interchangeable under appropriate circumstances.

The terms “comprise,” “include,” “have” and any variations thereof are used synonymously to denote non-exclusive inclusion. The term “exemplary” is used in the sense of “example,” rather than “ideal.”

In the interest of conciseness, conventional techniques, structures, and principles known by those skilled in the art may not be described herein, including, for example, the circuits supporting communications links between the various devices described herein.

Devices such as smartphones, laptops, and tablets (i.e., network-connected devices) include significant computing power that allows users to accomplish many tasks that would not have been possible with previous generation devices. Such devices typically provide a connection to large networks, such as the Internet, that allow users to transfer data associated with certain applications running on the devices. Such devices also provide connections to user communication services through, for example, a cellular network or the Internet, that allow user communication by voice, messaging, or email.

Associated accessory devices are designed to work in coordination with devices such as smartphones, where the accessory devices may not have the same amount of computing power or connectivity features. For example, an accessory device such as a smartwatch (i.e., an external communication device) may provide more limited resources in terms of memory and may not provide a direct connection to cellular services or the Internet. Instead, such accessory devices can leverage, for example, a smartphone to provide access to the Internet and cellular service, thereby enabling support for text messages, email, and telephone and Internet access. Other examples of accessory devices include wearable devices such as bracelets, pendants, other forms of jewelry, headsets, belts, clothing, eyeglasses, and earpieces.

A number of techniques for using such multiple-device systems are described herein. While many of the examples provided pertain to a smartwatch used in combination with a smartphone, such examples should not be viewed as limiting. For example, other accessory devices, including those listed above, can be used, and other mobile devices such as a tablet or laptop may also be a part of such systems. Moreover, the techniques described herein may be appropriate for the accessory device, the device with which the accessory device is paired, or systems that include both devices.

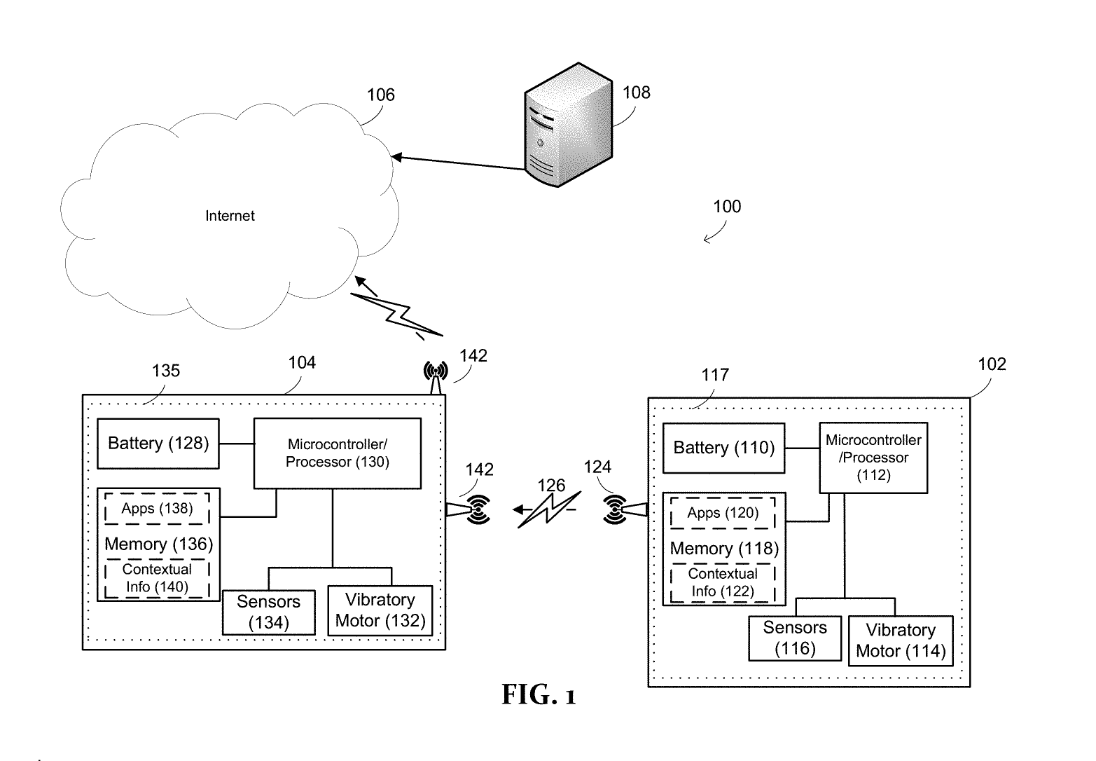

Turning now to FIG. 1, a system 100 that may be used with an embodiment of the present invention is shown. The system may comprise an external communication device 102, network-connected device 104, network 106, and remote server 108. The external communication device 102 may be, for example, an electronic accessory device that communicates with the network-connected device 104. While in the present embodiment the external communication device 102 is a smartwatch, non-exclusive examples of an external communication device include smartwatches (e.g., Pebble SmartWatch®), smart necklaces, smart earrings, and smart rings. The external communication device 102 may comprise a battery no, microcontroller or processor 112, vibratory motor 114, sensors 116 (e.g., GPS, accelerometer), display 117 (e.g., Liquid Crystal Display (“LCD”), such as e-paper and in-plane switching, and active-matrix organic light-emitting diode (“AMOLED”)) and memory 118. The memory 118 may include storage for applications 120 to be executed by the microcontroller or processor 112. The memory 118 may also store contextual information 122 gathered by the sensors 216 or other hardware of the device 102. It will be appreciated that the memory discussed herein may include volatile and non-volatile, removable and non-removable media implemented in any method or technology for storage of information, such as computer readable instructions, data structures, program modules, or other data. Examples of computer storage media include RAM, ROM, EEPROM, flash memory or any other medium which can be used to store electronic information and which can be accessed by a processor. The communication device 102 may be connected to the network-connected device 104 via wireless interface 124 using a wireless communication protocol 126, including but not limited to Bluetooth, ultra-wideband, ZigBee, or Wi-Fi. However, any connection may be suitable for connecting the external communication device 102 to the network-connected device 104, including known wired and wireless protocols. It will also be understood that the sensors 116 may include any sensors known in the art, including but not limited to a global position satellite (“GPS”), pulse sensor, heart rate monitor, accelerometer, gyroscope, thermometer, magnetometer, pressure sensor, orientation sensor, proximity sensor, light sensor, fingerprint sensor and infrared sensor.

The network-connected device 104 may comprise a battery 128, microcontroller/processor 130, vibratory motor 132, sensors 134, display 135 and memory 136. Non-exclusive examples of a network connected device 104 include smartphones (e.g., Apple iPhone®), laptop computers, and tablet devices (e.g., Apple iPad®). As with the external communication device 102, the memory 136 may store applications 138 for execution by the microcontroller/processors 130 and may also store contextual usage information 140 corresponding to the user's use of the network-connected device 104 and/or external communication device 102. The network-connected device 104 may be connected to the external communication device 102 via a wireless interface 142 using the wireless protocol 126. The network-connected device 104 may also be connected to a remote server 108 using a network, such as Internet 106, via network interface 142.

The remote server 108 may provide applications to network-connected device 104 and/or external communication device 102 via the Internet 106. The remote server 108 may also send and receive new communications to and from the network-connected device 104 and/or external communication device 102. Non-exclusive examples of such communications include text messages and/or messages provided by an application server, such as the server corresponding to the RunKeeper® application. The remote server 108 may also provide application updates to applications stored in the apps portion of memory 138 of the network-connected connected device 104 or to applications stored in the apps portion of memory 120 of the external communication device 102. The remote server 108 may also store user account information, where the account corresponds to the user of the network-connected device 104/external communication device 102. The remote server 108 may also modify the user account information based on information received from the network-connected device 104 and/or external communication device 102.

With regard to external communication device 102, an application stored in 120 may use the sensors 116 to selectively collect contextual information 122 for a particular purpose. For example, the well-known communication device application RunKeeper® may use a GPS sensor within sensors 116 in order to track the location of a user as the user jogs. The contextual information may be stored in memory 118 at 122. The application may then determine the length of time it took the user to complete the jog and store that information into memory 118 so the user may review it later. The contextual information 112 saved in memory 118 may be transmitted from the external communication device 102 to the network-connected device 104 via network interfaces 124 and 142. The network-connected device 104 may then transmit the contextual information 122 to the RunKeeper® remote server 108 via the Internet 106 so that the jogging information can be remotely stored and accessed later by the user. As yet another example, an accelerometer within sensors 116 may be used to determine when a user has begun to jog or run. When that activity has occurred, the microcontroller or processor 112 may automatically execute the RunKeeper® application. The RunKeeper® application may then automatically begin tracking the location of the user and determine the length of time it took the user to complete the jog. Alternatively, the sensors 116 of the external communication device 102 may be used to gather the contextual information 122, which may then be transferred to the network-connected device 104 so that the network-connected device 104 may execute an application, such as RunKeeper®. In this way, the application may run on the network-connected device 104, which in some cases may have greater processing power than the external communication device 102. However, even though the network-connected device 104 may execute the application, the user interface or user display associated with the application may be streamed or relayed from the network-connected device 104 to the external communication device 102. In this way, the user may view the contents of the application on the external communication device 120 while taking advantage of the processing power of the network-connected device 104 without having to actually execute the application on the external communication device 102. In instances where the external communication device 102 is a smaller accessory device, such as a smartwatch, and the network-connected device 104 is a smartphone, this may be particularly advantageous as the smartphone is likely to have greater processing power and storage capacity.

In an embodiment of the present invention, an improved method, system, and apparatus for tracking the contextual usage of a communication device is described. More specifically, in this embodiment the time that a user uses a particular watch face of a smartwatch (i.e., an external communication device) is tracked. Additional contextual information, such as the GPS location of the user, is used in conjunction with the watch face display time. Using the watch face display time and additional contextual information, the user may be granted a credit that can be used to obtain a particular reward or benefit. While GPS location and watch face display time are two categories of contextual usage information tracked in the present embodiment, it would be apparent to those having ordinary skill in the art that any category of contextual information may also be tracked, including but not limited to temperature, GPS location, watch face display time, accelerometer recordings, light sensor readings, pressure sensor readings, gyroscope readings, magnetometer readings, barometer readings, and proximity readings.

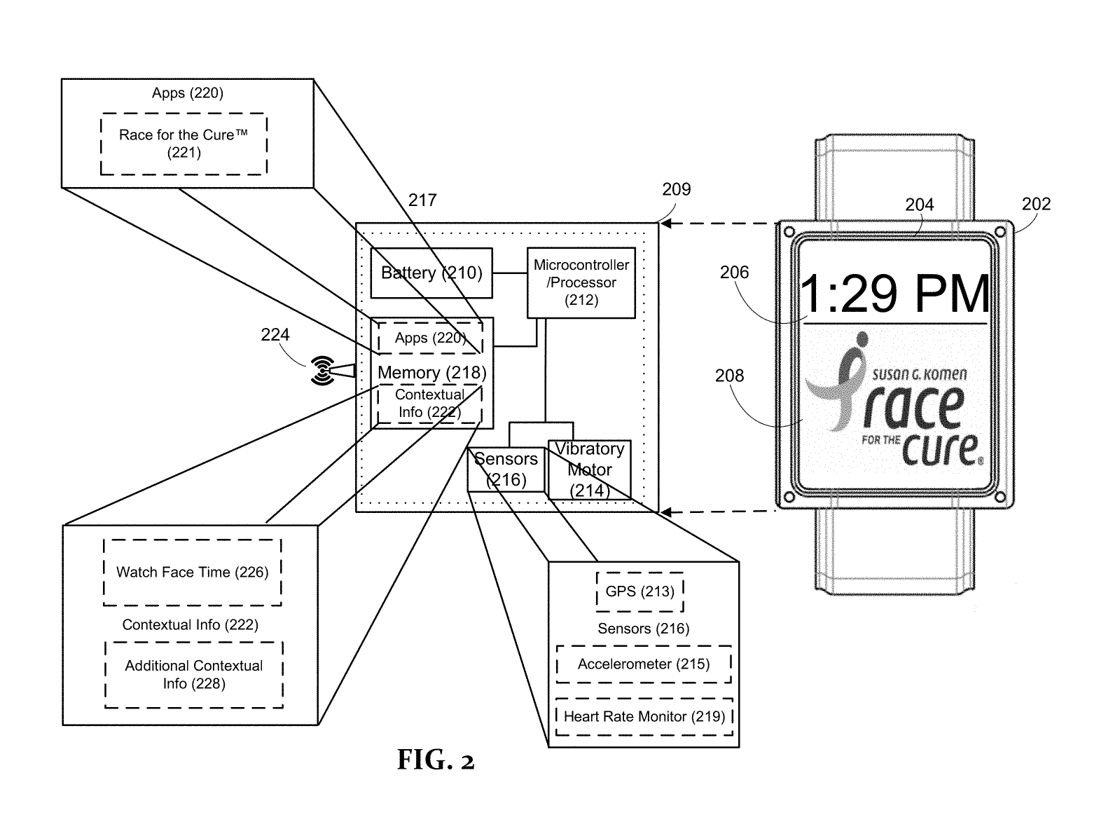

Turning now to FIG. 2, a smartwatch 202 (i.e., an external communication device) is illustrated, which has a display 204 for displaying a watch face and user interface. While in this embodiment the external communication device is a smartwatch 202, those having ordinary skill in the art would understand that the external communication device could be any number of known electronic devices in the art, such as a smart necklace or smart ear ring. The display 204 shows a watch face, which illustrates the time 206. Additionally, the watch face illustrates a logo or brand 208, which in this case is a “Race for the Cure”® logo. The “Race for the Cure”® is a well-known charity that generates money to help fight breast cancer. While digital promotional material in the form of logo 208 is used in this embodiment, those having ordinary skill in the art would understand that any digital promotional material of a company, organization, or individual could be used with the present invention. “Digital promotional material” as defined herein means any digital media intended to promote a product, service, organization, company, individual, cause, or institution that is displayed on computer device with the ability to wirelessly connect to a network.

A detailed hardware view of the smartwatch 202 is illustrated at 209, and that hardware is virtually identical to the hardware of external communication device 102 in FIG. 2. To avoid redundancy, hardware components previously addressed (e.g., sensor 216, vibratory motor 214) will not be addressed again here. The watch face of the display 204 may be selected using the Race for the Cure® application 221 stored in the apps section 220 of memory 218. In this embodiment, the watch face (which includes the logo 208) was selected by the user of the smartwatch 202 using the Race for the Cure® application 221. However, it should be understood that the watch face of the display 204 could also be selected using system settings of the smartwatch 202 or by another method. For instance, the watch face 204 could be selected remotely for the user by the developer of the application or by a remote computer elsewhere.

In this embodiment, the time in which the logo 208 (i.e., digital promotional material) is displayed by the user is tracked by the smartwatch 202 and stored into memory 218 as the promotional material display time 226. The promotional material display time 226 may then be transmitted to a network-connected device via network 224 interface so that it may be sent to the Race for the Cure® application server. Based on the promotional material display time 226, the application server may modify the user's account to grant the user a credit proportional to the amount of time the watch face logo 208 was displayed. The credit may be granted to an account of the user. The user may then spend or redeem the credit to acquire a benefit or reward. The term “credit” as used herein would be understood by those having ordinary skill in the art to be any quantifiable value which may be used by the receiver of the credit to obtain a benefit. A non-exclusive list of “credits” includes monies (e.g., a U.S. dollar), frequent flyer miles, electronic currency (e.g., Bitcoins, PayPal credit), and points (e.g., that can be used for an all-expenses paid vacation). While certain examples of “credits” have been set forth, the term “credit” is not intended to and should not be limited to these examples. Moreover, while in the disclosed embodiment the credit is granted an account of the user, a credit could be made by a third-party to an organization (e.g., a charity) based on the activity of the user. In other words, the credit could be granted to an organization on behalf of the user, rather than to the user. For example, a user's display of the Coke® promotional display material may earn credits that are awarded directly to a charity (e.g., Race for the Cure®) by Coke®, rather than to the user directly. In yet another embodiment, a user may grant credits directly to an organization (e.g., a charity) for every mile walked, rather than being awarded a credit.

While the embodiment may solely use the promotional material display time 226 to determine the amount of credits to be awarded, there may be specific contexts where the exposure of the logo 208 has more or less value to the developer of the application (e.g., the Race for the Cure® organization). For example, the exposure may have more value when the user of the smartwatch 202 is jogging, as it is more likely the logo 208 will be exposed to other joggers who may have a higher level of interest in the Race for the Cure® cause. Market studies conducted by the developer of the application may show that joggers are more likely to be persuaded to join the Race for the Cure® charity than non-joggers. In other words, the marketing potential of the logo 208 may be greater in specific contexts. Moreover, there may be times when the logo 208 has little to no marketing potential, and thus the developer of the application may not want those times to be credited to the user for crediting purposes. For example, when the user is sleeping the logo 208 may receive minimal to no exposure. In that case, it may be desirable to exclude the sleeping period from the promotional material display time 226 that is used to determine the amount of credits that should be granted to the user of the smartwatch 202. For these reasons, it may be beneficial to use additional contextual information, other than promotional material display time 226, in order to determine the amount of credits to be awarded to the user. This additional contextual information 228 may be gathered using one or more of the sensors within 216. Sensors 216 may include a GPS sensor 213, accelerometer 215, and heart rate monitor 219.

As stated above, the developer of the application may determine that the best exposure for the logo 208 occurs when the user is jogging, as that is when the user is most likely to be around other joggers that may have interest in the Race for the Cure® organization. As previously stated, the sensors 216 of the external communication device 202 may include a GPS sensor 213, accelerometer 215 and heart rate monitor 219. The accelerometer 215 may be used to determine when the wearer of the smartwatch 202 is performing the running motion with his or her arm. The GPS sensor 213 may be used to determine if the user is at a location likely to be populated with other runners, such as a well-known city park. Additionally, the GPS sensor may be used to track the distance the user of the smartwatch 202 runs, and award the user additional credits for each mile the user runs. The heart rate monitor 219 may also be used to determine whether the user is running or walking by detecting changes in the user's heart rate. In this embodiment, the contextual info 222 stored in memory 218 comprises both the promotional material display time 226 and additional contextual information 228. For example, if the user displays the logo 208 for an entire day, that information is stored in the promotional material display time 226 portion of memory 218. Additionally, the time in which the accelerometer detects that the user is running is stored in the additional contextual info 228 portion of memory 218. The race for the cure application 221 stored in the apps portion 220 of memory 218 may then send that information to the application server associated with the application 221 via the network interface 224, and the user may then be awarded a certain number of credits based on the requirements established by the application developer. For example, the application developer may decide that for every hour a user displays the logo 328 while jogging, the user will be awarded si to be donated to an approved charity of the user's choice. Alternatively, the user may use the awarded credit to purchase Race for the Cure® merchandise, which may help further promote a cause important to the user.

Additionally, the user may be awarded more credits if the user performs the jog at a particular location. For example, the user may be awarded additional credits for running at Central Park in New York City, as that may be a very populated jogging venue. Thus, in addition to using the accelerometer to determine when the user is jogging and the GPS sensor to determine the distance of the user's job, the GPS of sensors 216 may be used to track the specific location of the jog. The application 221 stored in apps 220 may then send that information to a remote application server associated with the application 221 via the network interface 224, and the user may then be awarded a certain number of credits based on predefined parameters established by the application developer.

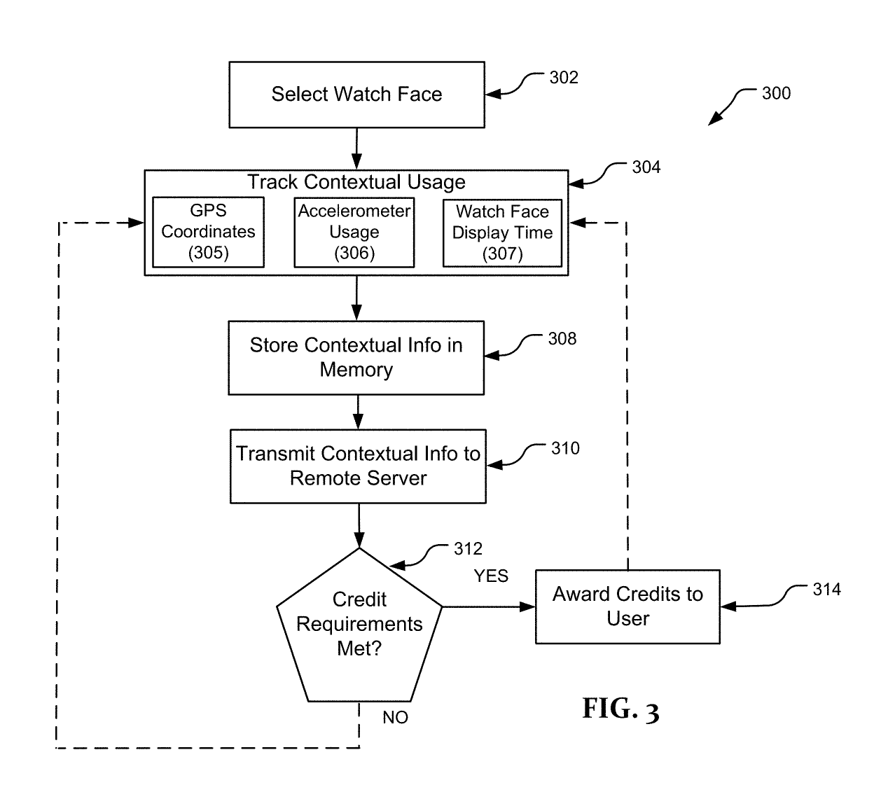

Turning now to FIG. 3, a flowchart illustrating a method 300 of the described embodiments is shown. At step 302 the user of the external communication device selects the appropriate watch face. In reference to the previous embodiment, the watch face may be the Race for the Cure® watch face, which includes the Race for the Cure® logo 208. The selection may be made via the Race for the Cure® application 221. Alternatively, the selection of the watch face may be made via the system settings of the smartwatch 202. The smartwatch 202 then begins tracking the contextual usage of the watch at step 304, which includes the GPS coordinates of the device 305, the accelerometer usage 306, and the watch face display time 307. That contextual information is then stored into the memory of the smartwatch at step 308. Next, the contextual information is transmitted to a remote server at step 310. As previously explained, the transmittal of the contextual information to the remote server may be via a network-connected device, or alternatively the smartwatch may directly transmit the contextual information to the remote server via the Internet. The remote server may be the application server corresponding to application 221, which as explained previously may store user account information of the smartwatch user. As an example, if the application is the Race for the Cure® application, then the application server may be associated with the Race for the Cure® application server, which stores all of the user's Race for the Cure® account information. Once the contextual information is received by the remote server, the remote server makes a determination as to whether specific credit parameters or requirements have been met at step 312. For instance, the remote server may be configured to award a credit to a user of the external communication device if the promotional material has been displayed for one hour while the user is jogging at Central Park in New York City. If the contextual information indicates that the user has met these requirements, at step 314 the user is awarded a credit for meeting those requirements. The process then repeats beginning with step 304. If at step 312 the contextual information indicates that the user has not met the requirements discussed above, the process restarts beginning with step 304.

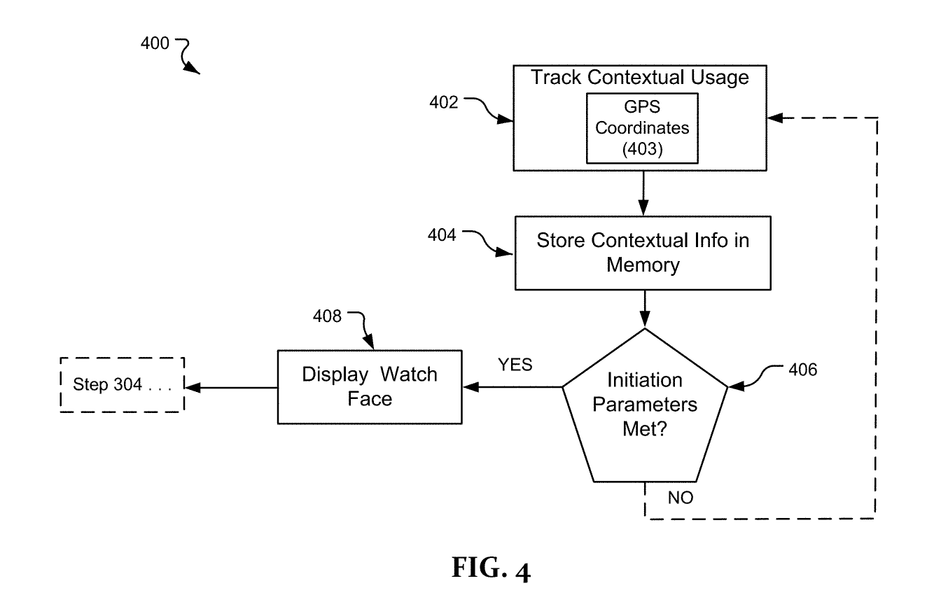

In yet another embodiment, the promotional material may be automatically displayed based on the context of the usage of the smart watch and then the method illustrated in FIG. 3 may follow. In reference to FIG. 4, the external communication device may track the contextual usage of the watch at step 402, which in this embodiment involves tracking the GPS coordinates 403 of the smartwatch. The contextual information is then stored into memory at step 404. At step 406, it is determined whether the stored contextual information falls within predetermined promotional material initiation parameters. The parameter may be, for example, whether the external communication device is at a particular location. The predetermined parameters may be established by an application on the external communication device and altered remotely by the application server associated with the application. If it is determined that the parameters have been met based on the contextual information, particular promotional material is displayed on the watch at step 408. After the promotional material has been displayed, the method continues beginning with step 304 in FIG. 3. When the tracked contextual information indicates that the smartwatch usage falls outside the predefined parameters, the displayed promotional material may be replaced with the digital content that was displayed on the watch prior to step 408.

It will be appreciated that this embodiment may be particularly advantageous, as it automatically applies the promotional material at the appropriate time. The predetermined parameters may be based, for example, on market studies that show that the promotional material is primarily beneficial to the developer of the watch face during particular contextual situations. For instance, in this embodiment the watch face developer may have determined that the promotional material is likely to receive the most beneficial exposure when the user of the external communication device is in close proximity to the developer's store. As such, the promotional material may only be displayed when the user is in close proximity to the developer's store. When the user is not close to the developer's store, another watch face of the user's choosing may be displayed. In this way, the user may receive credits for the most salient contextual usages of the watch without having to constantly display the developer's promotional material. Similarly, the developer will not be required to credit the user for displaying the promotional material when the context of the watch usage dictates the promotional material exposure is unlikely to attract additional customers or followers.

The present invention may benefit a user by awarding the user credit that can be redeemed or applied to acquire a reward or benefit of the user's choosing. Because the user is incentivized by the prospect of receiving credits for displaying particular promotional material, the user may be more likely to display the promotional material. This may be beneficial to the designer of the promotional material, as the more individuals exposed to the promotional material may increase the likelihood that the exposed individuals will buy or endorse the developer's products or charity. For example, the more individuals exposed to the Race for the Cure® logo may increase the likelihood that other individuals will in some way donate to the cause or join the organization. Similarly, the more individuals exposed to the “Gucci” brand logo may be more likely to buy Gucci brand products. An important feature of the present invention is that the precise contextual usage of a communication device may be determined using sensors and other hardware, which may allow the developer of a watch face to more effectively promote the developer's brand or products while at the same time rewarding loyal customers or organizational supporters.

While the disclosed embodiments relate primarily to the Race for the Cure® logo and its corresponding application and awarding credits based on contextual information relating to GPS location, accelerometer use, and promotional material display time, those of skill in the art would understand that the present invention may apply to any logo or brand and that credits may be awarded based on any combination of contextual information. A non-exclusive list of additional use cases are set forth.

In one example use case, Coca-Cola® may create a watch face that displays the “Coke” logo and that awards the wearer of the watch credits based solely on the amount of time the logo is displayed. Thus, in this proposed embodiment the only contextual information used to make a determination as to whether a credit should be awarded is the tracked display time of the watch face. Alternatively, Coke® may desire to exclude display time associated with the sleep period of the user, as exposure of the watch display to other users may be very limited in that period. Coke® may then use an accelerometer and pulse sensor in the watch to detect movements (or the lack thereof) associated with sleep and to detect a lower heart rate, which may be associated with sleep. Using that contextual information, Coca-Cola® may subtract the user's predicted sleep period from the overall watch face display time and award the wearer of the watch credit for the remaining watch face display time. The awarded credit may be in the form U.S. currency so that it can be used to purchase any item desired by the user. Alternatively, the credit may take the form of credits that may be used at Coke vending machines to purchase Coke® products or at Coke's® website to redeem products.

In yet another example, Wal-Mart® may provide its store employees with a smart watch containing a GPS sensor. When an employee is within close proximity of the store, the watch may automatically launch a Wal-Mart® watch face, which displays the Wal-Mart® logo. Additionally, the watch face may display special sales or offers currently on promotion when the employee is in the store. This may aid the employee in being aware of current special offers and sales so that the employee may be able to more readily present the offer and sale to store customers. It will be appreciated that this system may be fully automated so that the Wal-Mart® employees would need not take any action for the Wal-Mart® watch face to be displayed. This may be particularly advantageous, as Wal-Mart® employees would then not need to be manually informed of current special offers and sales when they arrive.

In yet another example, Nike® may provide an external watch application that automatically displays the Nike® watch face on a user's external communication device when the user is in proximity of certain sports apparel stores. For example, when a user is in proximity of a Dick's Sporting Goods®, the application may automatically initiate the Nike watch face when the tracked contextual information (e.g., GPS coordinates) indicate the user is within close proximity to the store. The user may then be accorded credits based on the total amount of time the watch face is displayed while the user is within proximity of the store. When the user leaves the proximity of the store, the watch face will be replaced with the watch face that was displayed prior to the Nike® watch face being automatically displayed. In this way, the user only temporarily displays the Nike® watch face when in proximity of stores where potential customers of Nike® are already present.

While the presently disclosed embodiments are implemented primarily on an external communication device, those of skill in the art would understand the disclosed invention could be implemented on any communication device, including network connected devices (e.g., a smartphone or tablet device). Moreover, while the determination of credits in the disclosed embodiments are performed by a remote server, those having ordinary skill in the art would understand that the determination could be made on a network connected device, such as a smartphone or tablet device, or an external device, such as a smartwatch.

It will also be understood that the above description is intended to be illustrative, and not restrictive. For example, the above-described embodiments may be used in combination with each other and features of one embodiment may be utilized with other embodiments. Many other embodiments will be apparent to those of ordinary skill in the art upon reviewing the above description. For example, the invention may be implemented in other wearable technologies other than watches, such as wearable necklaces, ear rings, etc. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A wearable device, comprising:
a display;
at least one sensor;
at least one processor capable of executing an application, the application configured to:
provide content to the display, based at least in part on a type of physical activity;
track a display time corresponding to the content, wherein the display time comprises an amount of time the content is presented on the display; and
generate contextual data, the contextual data based at least on the display time and on sensor data collected by the at least one sensor;
memory for storing compiled data, the compiled data including at least the display time and the contextual data; and
a network interface configured to transmit the compiled data and receive an amount of credits, the amount of credits based at least in part on one of the display time, the type of physical activity, or a geographic location associated with the type of physical activity.

2. The wearable device of claim 1, wherein the amount of credits received is based on the display time exceeding a predetermined threshold.

3. The wearable device of claim 1, wherein the at least one sensor comprises at least one of a global positioning satellite-based sensor, an accelerometer, a heart rate sensor, a pulse sensor, a gyroscope, a thermometer, a magnetometer, a pressure sensor, an orientation sensor, a proximity sensor, a light sensor, a fingerprint sensor, or an infrared sensor.

4. The wearable device of claim 1, wherein the contextual data includes the geographic location associated with the type of physical activity.

5. The wearable device of claim 1, wherein the amount of credits received comprises a first amount of credits based at least in part upon a first physical activity engaged at a first geographic location and grants a second amount of credits based at least in part upon a second physical activity engaged at a second geographic location.

6. The wearable device of claim 1, wherein the wearable device is a smartwatch.

7. The wearable device of claim 1, wherein the network interface is configured to wirelessly communicate with a remote computing system.

8. The wearable device of claim 1, wherein the content is presented on the display based on a determination that a predetermined threshold of contextual data of the wearable device has been met.

9. The wearable device of claim 1, wherein the application is configured to permit selection of an instance of the content, for presentation on the display, from among a set of the content.

10. A computer-implemented method, comprising:
receiving display time data from a wearable device, the display time data comprising an amount of time that content is presented on a display of the wearable device;
receiving contextual data from the wearable device, the contextual data based at least in part on the display time and on sensor data collected by at least one sensor associated with the wearable device;
determining that the display time exceeds a predetermined threshold;
analyzing physical activity data of the contextual data to identify a type of physical activity and a geographic location associated with the type of physical activity; and
determining an amount of credits based at least in part on at least one of the type of physical activity or the geographic location.

11. The computer-implemented method of claim 10, wherein the at least one sensor comprises at least one of a global positioning satellite-based sensor, an accelerometer, a heart rate sensor, a pulse sensor, a gyroscope, a thermometer, a magnetometer, a pressure sensor, an orientation sensor, a proximity sensor, a light sensor, a fingerprint sensor, and an infrared sensor.

12. The computer-implemented method of claim 10, wherein the determination of an amount of credits comprises granting a first amount of credits based at least in part upon a first physical activity engaged at a first geographic location and granting a second amount of credits based at least in part upon a second physical activity engaged at a second geographic location.

13. The computer-implemented method of claim 10, further comprising:
providing content to the wearable device based on a determination that a predetermined threshold of contextual data of the wearable device has been met.

14. The computer-implemented method of claim 10, wherein the wearable device is a smartwatch having a network interface configured to wirelessly communicate with a remote server.

15. The computer-implemented method of claim 10, further comprising:
receiving a selection of an instance of the content, for presentation on the display of the wearable device, from among a set of the content.

16. The computer-implemented method of claim 10, wherein the contextual data includes the geographic location associated with the type of physical activity.

17. A computing system, comprising:
at least one processor; and
memory including instructions that, when executed by the at least one processor, cause the computing system to:
receive display time data from a wearable device, the display time data comprising an amount of time that content is presented on a display of the wearable device;
receive contextual data from the wearable device, the contextual data based at least in part on the display time and on sensor data collected by at least one sensor associated with the wearable device;
determine that the display time exceeds a predetermined threshold;
analyze physical activity data of the contextual data to identify a type of physical activity and a geographic location associated with the type of physical activity; and
determine an amount of credits based at least in part on at least one of the type of physical activity or the geographic location.

18. The computing system of claim 17, wherein the at least one sensor comprises at least one of a global positioning satellite-based sensor, an accelerometer, a heart rate sensor, a pulse sensor, a gyroscope, a thermometer, a magnetometer, a pressure sensor, an orientation sensor, a proximity sensor, a light sensor, a fingerprint sensor, and an infrared sensor.

19. The computing system of claim 17, wherein the determination of an amount of credits comprises granting a first amount of credits based at least in part upon a first physical activity engaged at a first geographic location and granting a second amount of credits based at least in part upon a second physical activity engaged at a second geographic location.

20. The computing system of claim 17, wherein the instructions, when executed by the at least one processor, further cause the computing system to:
provide content to the wearable device based on a determination that a predetermined threshold of contextual data of the wearable device has been met.
